(19) United States
(12) Patent Application Publication
(10) Pub. No.: US 2008/0116198 A1
(43) Pub. Date: May 22, 2008

(54) Microwave oven with multiple power supply paths

(75) Inventor: Tim Frank, Asheville, NC (US)

Correspondence Address: CARTER & SCHNEDLER, P.A., 56 CENTRAL AVENUE, SUITE 101, P.O. BOX 2985, ASHEVILLE, NC, 28802, US

(73) Assignee: The Frank Group, LLC, Asheville, NC (US)

(21) Appl. No.: 11/603,408

(22) Filed: Nov. 21, 2006

(51) Int. Cl. H05B 6/64; H05B 6/68

(52) U.S. Cl. 219/678; 219/702

(57) ABSTRACT

A microwave oven including an oven housing defining an oven chamber, a magnetron in the oven housing, and three alternative paths along which electrical power may be supplied to the magnetron, the three alternative power supply paths including an alternating current (AC) power supply path that enables the oven to be electrically connected directly to AC mains, a first direct current (DC) power supply path that enables the oven to be electrically connected directly to an electrical socket in a motor vehicle, and a second DC power supply path that enables the oven to be electrically connected directly to a battery.

### BRIEF DESCRIPTION OF THE DRAWINGS

FIG. 1 is an anterior perspective view of a microwave oven according to a first embodiment of the invention;

FIG. 2 is an anterior perspective view of the microwave oven shown in FIG. 1 with the door of the oven in an open position;

FIG. 3 is a posterior perspective view of the microwave oven shown in FIG. 1;

FIG. 4 is an anterior perspective view of a microwave oven according to a second embodiment of the invention;

FIG. 5 is an anterior perspective view of the microwave oven shown in FIG. 4 with the door of the oven in an open position;

FIG. 6 is a posterior perspective view of the microwave oven shown in FIG. 4;

FIG. 7 is a schematic diagram of power supply circuitry in the microwave ovens shown in FIGS. 1 and 4;

FIG. 8 is a schematic diagram of a microprocessor and associated control circuitry in the microwave ovens shown in FIGS. 1 and 4.

### DETAILED DESCRIPTION

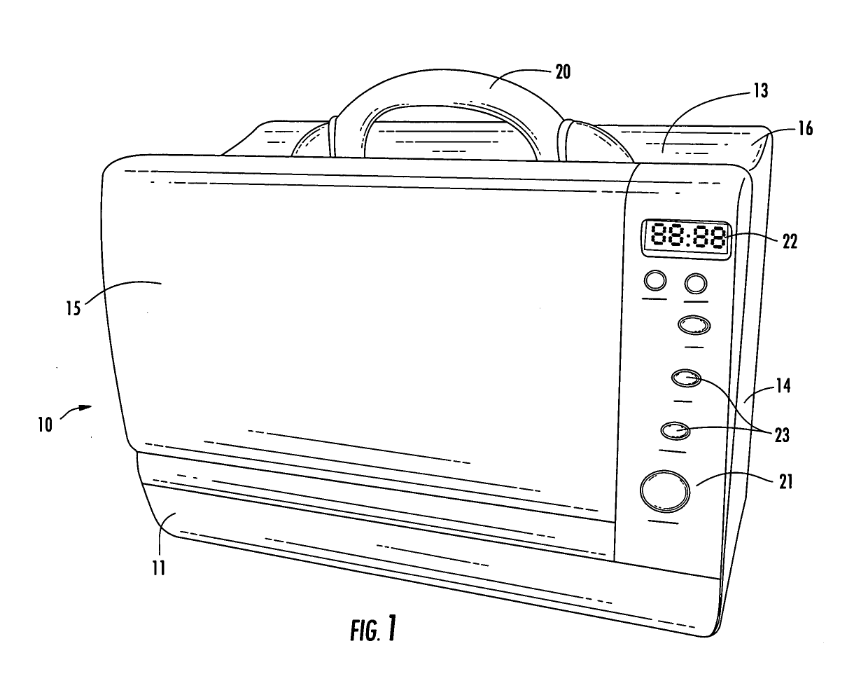

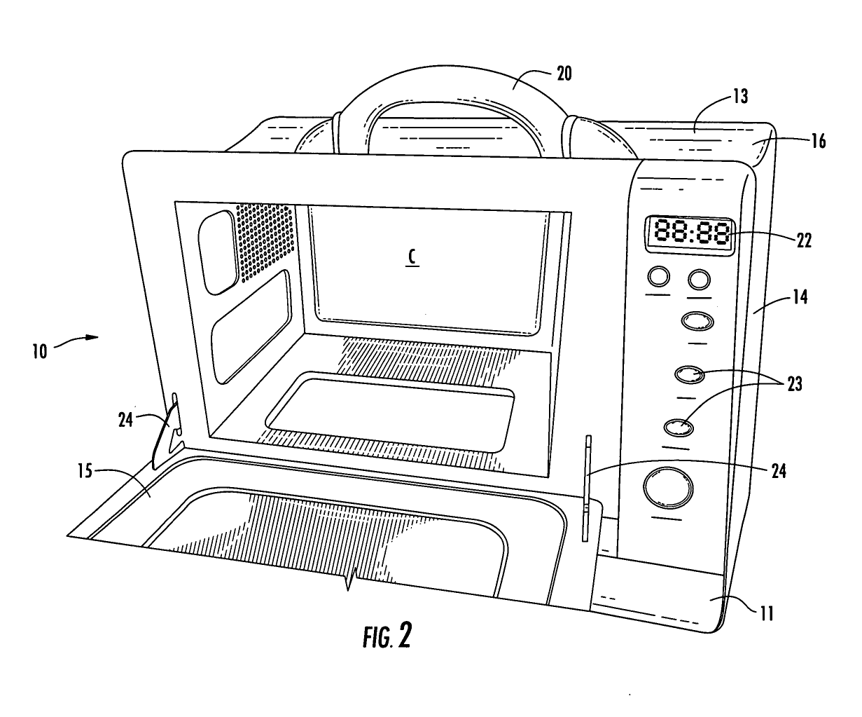

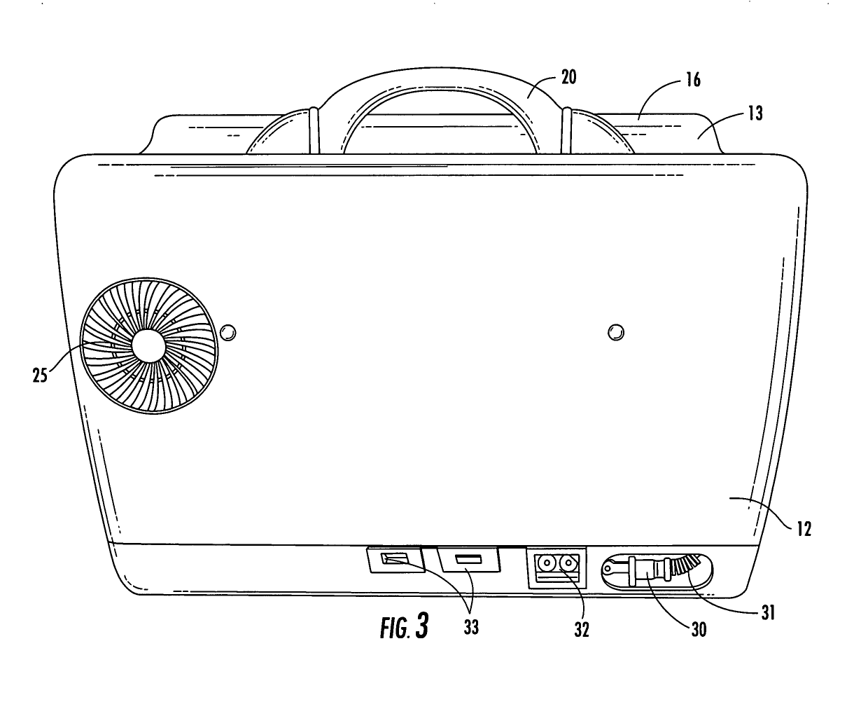

A first embodiment of a microwave oven according to the invention is shown broadly at reference numeral 10 in FIG. 1. The oven 10 includes a housing 16 having an anterior surface 11, a posterior surface 12 (FIG. 3), a top surface 13, a bottom surface (not shown), a right side surface 14, and a left side surface (not shown). The housing 16 houses, among other components, a magnetron (not shown). A door 15 is mounted to the anterior surface 11 of the oven housing 16. A handle 20 is mounted on the top surface 13 of the oven housing 16 in an orientation substantially parallel to the longitudinal axis of the top surface 13. A control panel 21 including a display 22 and a plurality of control buttons 23 is provided on the anterior surface 11 of the oven housing 16. Turning now to FIG. 2, the door 15 is shown in an open position to show an oven chamber “C” defined by the oven housing 16. Hinges 24 are attached to the door 15 and the oven 10 in order to enable the door 15 to be opened and closed without being detached from and re-attached to the oven 10.

The oven 10 comprises three power supply paths, each of which includes a power input connector configured to interface with a power output connector connected to a power source. The three power supply paths are (1) an alternating current (AC) power supply path that includes an AC power input connector comprising a two-prong plug 30 (FIG. 3) that complies with the 1-15 standard promulgated by the National Electrical Manufacturers Association; (2) a first direct current (DC) power supply path that includes a first DC power input connector comprising a substantially cylindrical barrel plug (not shown) configured to be received by a cigarette-lighter-style accessory power socket (not shown) in a motor vehicle; and (3) a second DC power supply path that includes a second DC power input connector comprising a pair of polarized clips or clamps such as alligator clips (not shown) configured to be attached directly to terminal posts on a motor vehicle battery. Thus, the AC power supply path is configured to be electrically connected to AC mains (approximately 110-120 volts AC at 60 Hz (United States) or 220-240 volts AC at 50 Hz (international)) while the first and second DC power supply paths are configured to be electrically connected to a motor vehicle battery (approximately 12 (consumer) or 24 (commercial) volts DC).

The oven 10 comprises cabling 31 that hardwires the two-prong plug 30 to the oven 10. Alternatively, the oven 10 could define a jack (not shown) for receiving cabling (not shown) that terminates in the two-prong plug 30. Rather than providing cabling that hardwires the second and third power input connectors to the oven 10, the posterior surface 12 of the oven housing 16 defines a jack 32 for receiving a cable (not shown) that terminates in the first DC power input connector (the barrel plug; not shown) and a pair of jacks 33 for receiving two cables (not shown) that terminate in the second DC power input connector (the pair of polarized alligator clips; not shown). Alternatively, the oven 10 could comprise cables that hardwire the first and/or second DC power input connectors to the oven 10. The posterior surface 12 of the oven housing 16 also defines a vent 25 proximal to a fan (not shown) housed in the oven housing 16.

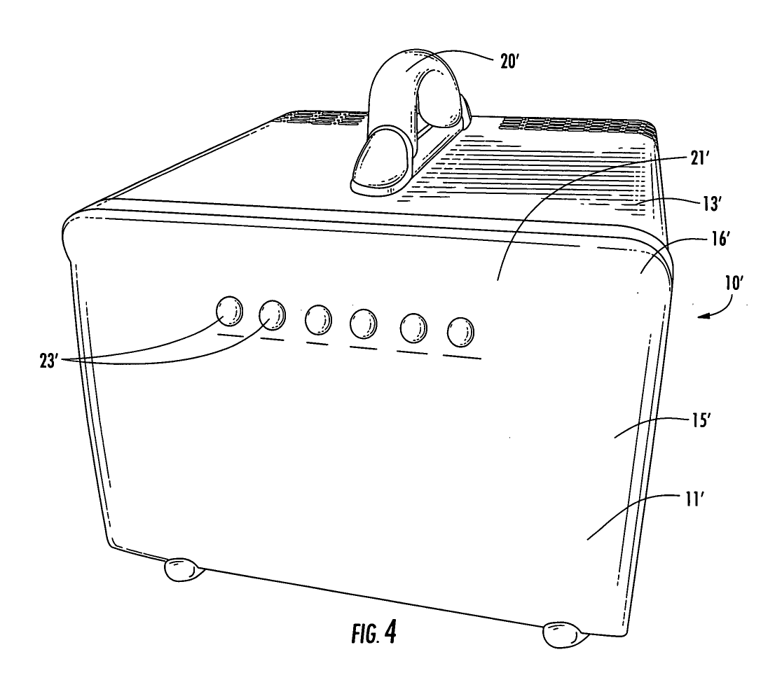

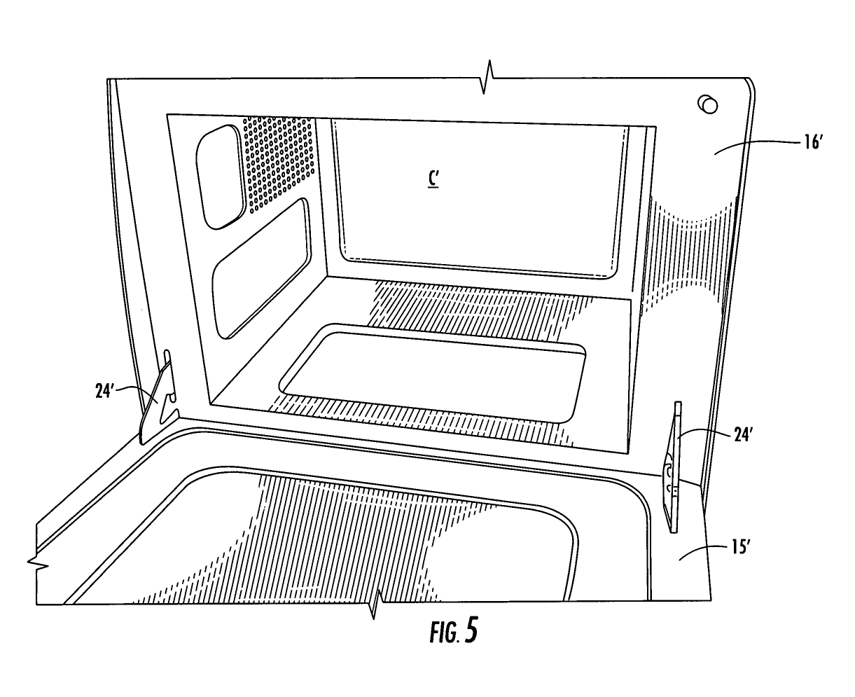

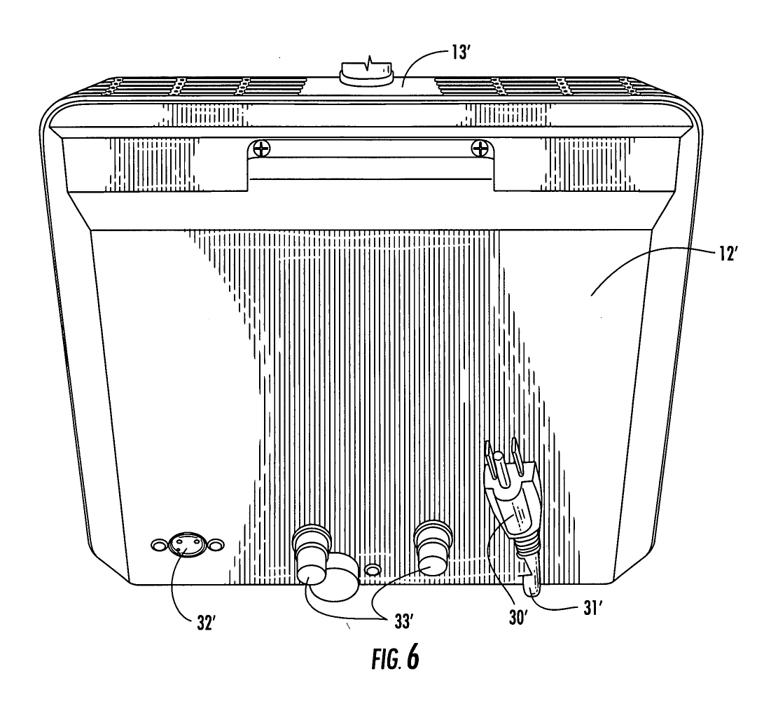

FIGS. 4, 5, and 6 illustrate a second embodiment 10′ of the microwave oven of the invention. The second embodiment 10′ is a more heavy-duty embodiment of the invention. Like the first embodiment 10, the second embodiment 10′ includes a housing 16′ that houses, among other things, a magnetron (not shown); the housing 16′ includes an anterior surface 11′, a posterior surface 12′ (FIG. 6), a top surface 13′, a bottom surface (not shown), a right side surface (not shown), and a left side surface (not shown). Also like the first embodiment 10, the second embodiment 10′ includes a door 15′ mounted to the anterior surface 11′ of the oven housing 16′; a handle 20′ mounted on the top surface 13′ of the oven housing 16′; a control panel 21′ including a plurality of control buttons 23′ on the anterior surface 11′ of the oven housing 16′; an oven chamber “C′” (FIG. 5) defined by the oven housing 16′; and hinges 24′ (FIG. 5) attached to the door 15′ and the oven 10′ in order to enable the door 15′ to be opened and closed without being detached from and re-attached to the oven 10′. The oven housings 16, 16′ in the disclosed embodiments of the oven 10, 10′ are formed primarily of acrylonitrile butadiene styrene (ABS) plastic (first embodiment), and ABS plastic and metal (second embodiment). However, the handle 20′ in the second embodiment 10′ is perpendicular to the longitudinal axis of the top surface 13′ of the oven 10′. In addition, unlike in the first embodiment 10, the AC power input connector in the second embodiment 10′ is a three-prong plug 30′ that complies with the 5-15 standard promulgated by the National Electrical Manufacturers Association and the second DC input connector is a pair of binding posts 33′ configured to receive bare wires.

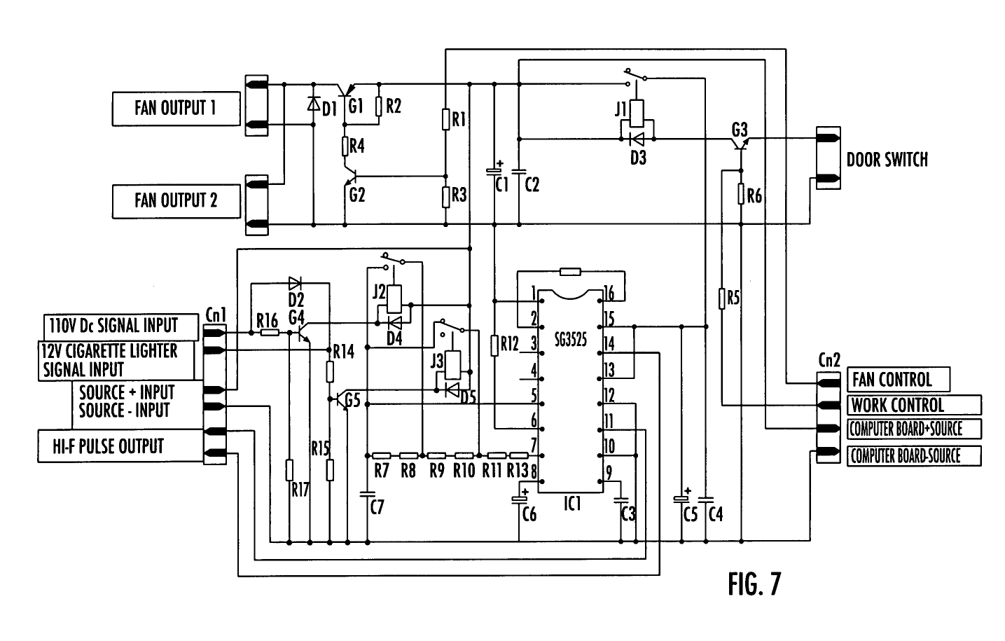

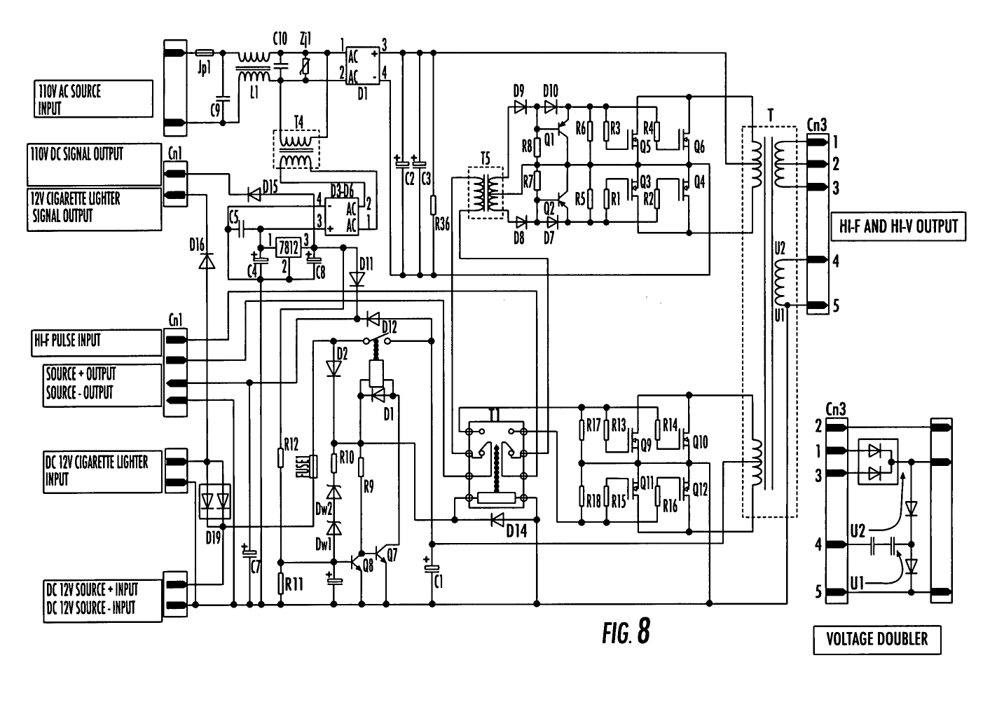

Turning now to FIGS. 7 and 8, schematic diagrams of internal electrical circuitry of the oven 10, 10′ are shown. The same circuitry is utilized in both disclosed embodiments of the oven 10, 10′. FIGS. 7 and 8 illustrate schematic diagrams of control circuitry and power circuitry of the oven 10, 10′, respectively; as is known by those of ordinary skill in the art, the oven 10 also includes circuitry connected to the control panel 21, 21′, but such circuitry is not illustrated. The control circuitry (FIG. 7) includes a microprocessor “IC1” that controls, among other things, the frequency of the power signal through the “HI-F PULSE OUTPUT” conductors in the control circuitry. The power circuitry (FIG. 8) includes a push-pull power supply utilized to convert the 110 or 120 VDC or 12 VDC input signal to high-voltage, high-frequency pulsating DC, which powers the magnetron of the oven 10, 10′. FIG. 8 further illustrates voltage doubler circuitry that increases the output voltage of the push-pull power supply to a level acceptable by the magnetron.

The oven circuitry is designed with safety and/or protective circuitry such that if the AC power input connector and one or both of the DC power input connectors are connected to power sources, the circuitry will accept and pass only the AC power signal; if both DC power input connectors are connected to power sources and the AC power input connector is disconnected, the oven circuitry will accept and pass only the DC power signal from the second DC power input connector, i.e., the pair of alligator clips connected to the motor vehicle battery.

Parts lists showing the values and ratings of the various components in the control and power circuitry and voltage doubler are shown below.

CONTROL CIRCUITRY (FIG. 7)

| Description | Specification | Part Nos. on Diagram |
|---|---|---|
| ¼ W Resistance | 100 ohm | R39 |
| ¼ W Resistance | 680 ohm | R42 |
| ¼ W Resistance | 1K | R36, R44 |
| ¼ W Resistance | 2K | R28, R29, R32, R33, R45, R47 |
| ¼ W Resistance | 2K | R49, R51, R52, R53 |
| ¼ W Resistance | 5.1K | R35, R37, R40 |
| ¼ W Resistance | 10K | R27, R30, R31, R34, R46, R48 |
| ¼ W Resistance | 10K | R50, R54 |
| ¼ W Resistance | 12K | R38 |
| ¼ W Resistance | 3K | R41 |
| ¼ W Resistance | 4.7K | R43 |
| CBB Capacitance | 104 | C18, C19, C24, C26, C25, C29 |
| CBB Capacitance | 272 | C28 |
| Electrolytic Capacitance | 16 V/470 UF | C17 x2 |
| Electrolytic Capacitance | 16 V/100 UF | C20 |
| Electrolytic Capacitance | 16 V/47 UF | C23, C27 |
| Electrolytic Capacitance | 50 V/10 UF | C22 |
| Diode | 1N4148 | D25, D26, D27 |
| Audion | 8050 | Q15, Q16, Q18, Q19, Q20, Q21 |
| Audion | 8050 | Q22, Q23 |
| Audion | 8550 | Q17 |
| Audion | B772 | Q14 |
| IC Integrated | SG3525 | IC2 |
| Regulated Resistance | 5K | A1, A3 |
| Regulated Resistance | 1K | A2 |
| Circuitry Board | HX-A002 | |

POWER CIRCUITRY (FIG. 8)

| Description | Specification | Part Nos. on Diagram |
|---|---|---|
| Circuitry Board | HX-A001 | |
| ¼ W Resistance | 1.5 ohm | R25 |
| ¼ W Resistance | 5.1K | R5, R6, R16, R17 |
| ¼ W Resistance | 10K | R9, R10, R11 |
| ¼ W Resistance | 1K | R13 |
| ¼ W Resistance | 5.1 ohm | R1, R2, R3, R4 |
| ¼ W Resistance | 5.1 ohm | R15, R18, R19, R20 |
| ¼ W Resistance | 2K | R25, R12, R14 |
| 1 W Resistance | 30 ohm | R21, R22, R23, R24 |
| 2 W Resistance | 18 ohm | R8 |
| 2 W Resistance | 30K | R7 |
| Diode | 1N4007 | D1, D2, D3, D4, D10 |
| Diode | 1N4007 | D11, D18 |
| Diode | 1N4148 | D5, D6, D7, D12 |
| Diode | 1N4148 | D13, D14, D15, D16 |
| Diode | 1N4148 | D17, D19, D20 |
| Diode | 14 V Stabilization | D9 |
| Diode | 4.3 V Stabilization | D21 |
| CBB Capacitance | 104 | C5 |
| CBB Capacitance | 223 | C11, C12 |
| CBB Capacitance | 2 KV\102 | C13, C14 |
| Electrolytic Capacitance | 25 V/10000 UF | C1, C15 |
| Electrolytic Capacitance | 200 V/200 UF | C2, C3 |
| Electrolytic Capacitance | 16 V1000 UF | C4, C7 |
| Electrolytic Capacitance | 16 V100 UF | C6, C8 |
| CBB Capacitance | | C9, C10 |
| Audion | 8050 | Q3, Q4 |
| Audion | 8550 | Q1, Q2 |
| MOS Tube | IRF840 | Q5, Q6, Q7, Q8 |
| MOS Tube | 1RF75N75 | Q9, Q10, Q11, Q12 |
| IC Integrated | 7812 | IC1 |
| IC Integrated | 3020 | D21 |
| IC Integrated | GBU1010 | D22 |
| Sensitive Resistance | 160 V | ZJ1 |
| Fuse | 35 A | FUSE1 |
| Isolated Transformer | | T13 |
| AC Transformer | 110 V/0.4 A | T2 |
| Relay | 30 A | K3 |
| Relay | 10 A | K2 |
| Relay | 5 A | K1 |
| AC Inductance Winding | | L1 |
| Hi-F Hi-V Transformer | | T1 |

VOLTAGE DOUBLER (FIG. 8)

| Description | Specification | Part Nos. on Diagram |
|---|---|---|
| Hi-Voltage Capacitance | 2 KV/102 | C30, 031 |
| Hi-Voltage Diode | 2CL2FD | D28, D29 |
| IC Integrated | MUR3020 | D30 |
| Circuitry Board | HX-A004 | |

A user may power the oven 10, 10′ merely by selecting a power supply path, i.e., by selecting one of the three power input connectors—an AC plug, a barrel plug, or a pair of alligator clips, as described above—and connecting the selected power input connector to a compatible power source—an AC outlet, an accessory power socket in a motor vehicle, or terminal posts on a motor vehicle battery, respectively, as described above.

A microwave oven with multiple power supply paths is described herein. Various details of the invention may be changed without departing from its scope. Furthermore, the foregoing description of the invention is provided for the purpose of illustration only and not for the purpose of limitation—the invention being defined by the claims.

What is claimed is:

1. A microwave oven, comprising:
an oven housing;
a magnetron in the oven housing; and
three alternative paths along which electrical power may be supplied to the magnetron, the three alternative power supply paths comprising an alternating current (AC) power supply path that enables the oven to be electrically connected directly to AC mains, a first direct current (DC) power supply path that enables the oven to be electrically connected directly to an electrical socket in a motor vehicle, and a second DC power supply path that enables the oven to be electrically connected directly to a battery.

2. A microwave oven according to claim 1, wherein the AC power supply path comprises an AC power input connector, the first DC power supply path comprises a first DC power input connector, and the second DC power supply path comprises a second DC power input connector.

3. A microwave oven according to claim 2, wherein the AC power input connector is an AC power plug that complies with either the 1-15 or 5-15 standard promulgated by the National Electrical Manufacturers Association.

4. A microwave oven according to claim 2, wherein the electrical socket is an accessory power socket and the first DC power input connector is a barrel plug configured to be received by the accessory power socket.

5. A microwave oven according to claim 2, wherein the battery is a motor vehicle battery comprising terminal posts and the second DC power input connector is a pair of polarized clips configured to be attached to the terminal posts of the motor vehicle battery.

6. A microwave oven, comprising:
an oven housing;
a magnetron in the oven housing;
three alternative paths along which electrical power may be supplied to the magnetron, the three alternative power supply paths comprising an alternating current (AC) power supply path that enables the oven to be electrically connected directly to AC mains, a first direct current (DC) power supply path that enables the oven to be electrically connected directly to an accessory power socket in a motor vehicle, and a second DC power supply path that enables the oven to be electrically connected directly to a motor vehicle battery comprising terminal posts; and
the AC power supply path comprising an AC power input connector, the first DC power supply path comprising a first DC power input connector, and the second DC power supply path comprising a second DC power input connector.

7. A microwave oven according to claim 6, wherein the AC power input connector is an AC power plug that complies with either the 1-15 or 5-15 standard promulgated by the National Electrical Manufacturers Association.

8. A microwave oven according to claim 6, wherein the first DC power input connector is a barrel plug configured to be received by the accessory power socket.

9. A microwave oven according to claim 6, wherein the second DC power input connector is a pair of polarized clips configured to be attached to the terminal posts of the motor vehicle battery.

10. A method for powering a microwave oven, comprising:
providing a microwave oven comprising an oven housing, a magnetron in the oven housing, and three alternative paths along which electrical power may be supplied to the magnetron, the three alternative power supply paths comprising an alternating current (AC) power supply path that enables the oven to be electrically connected directly to AC mains, a first direct current (DC) power supply path that enables the oven to be electrically connected directly to an electrical socket in a motor vehicle, and a second DC power supply path that enables the oven to be electrically connected directly to a motor vehicle battery comprising terminal posts, the AC power supply path comprising an AC power input connector, the first DC power supply path comprising a first DC power input connector, and the second DC power supply path comprising a second DC power input connector;
selecting one of the power supply paths by selecting either the AC power input connector, the first DC power input connector, or the second DC power input connector; and
connecting the selected power input connector to a compatible power source.

11. A method according to claim 10, wherein the AC power input connector provided in said providing step is an AC power plug that complies with either the 1-15 or 5-15 standard promulgated by the National Electrical Manufacturers Association.

12. A method according to claim 10, wherein the electrical socket provided in said providing step is an accessory power socket and the first DC power input connector provided in said providing step is a barrel plug configured to be received by the accessory power socket.

13. A method according to claim 10, wherein the second DC power input connector provided in said providing step is a pair of polarized clips configured to be attached to the terminal posts of the motor vehicle battery.
